(19) United States
(12) Patent Application Publication
(10) Pub. No.: US 2011/0221660 A1
(43) Pub. Date: Sep. 15, 2011

(54) Self-luminescent Display Device, Display Method and Portable Computer of the Same

(76) Inventors: HAO TANG, Taipei Hsien (TW); Hou-Cheng Chen, Taipei Hsien (TW)

(21) Appl. No.: 12/789,477

(22) Filed: May 28, 2010

(30) Foreign Application Priority Data
Mar. 12, 2010 (CN) 201010123107.7

(51) Int. Cl. G09G 3/30; G09G 3/20

(52) U.S. Cl. 345/76; 345/55

(57) ABSTRACT

A self-luminescent display device for an electronic device includes a display screen and a display controller. The display screen is utilized for displaying pictures via a plurality of self-luminescent elements, and includes a data display area for displaying an image and a status display area for displaying a status information of the electronic device. The display controller is utilized for receiving an image data corresponding to the image and a control signal corresponding to the status information, to drive the data display area and the status display area to display the image and the status information, respectively.

### BACKGROUND OF THE INVENTION

1. Field of the Invention

The present invention relates to a self-luminescent display device and display method and portable computer, and more particularly, to a self-luminescent display device and display method and portable computer displaying a status information of an electronic device via a part of a display screen.

2. Description of the Prior Art

A portable computer has the merits of its small size, light weight, and portability. Such that a user can work outside an office with ease and still utilize all functions of a computer system without being tied to a desk by a cumbersome personal computer (PC). In order to conveniently inform users about operating status, portable computers are all equipped with various indicator lights for indicating related messages.

Please refer to FIG. 1, which is a schematic diagram of a conventional portable computer 10. The portable computer 10 displays images via a display screen 100, and controls light emitting diode (LED) indicator lights Led_1-Led_n to switch on/off or blink to indicate corresponding information, such as battery status (charge or not), num lock status, caps lock status, WLAN card status and Bluetooth status. However, by utilizing the LED indicator lights Led_1-Led_n to reveal operating information, extra lights and related circuits are required. And switching on/off or blinking to indicate system status are not particularly helpful for realization of system integration.

In addition, during a research and development stage, if a debug card is used for debugging, a signal line and a power line of a peripheral component interconnect express (PCI Express) slot are reserved for the debug card. However, the power line is removed after production. As a result, if the debug card is utilized for debugging after production, the device needs to be disassembled for rework, causing great inconvenience. Thus, there is a need for improvement.

### SUMMARY OF THE INVENTION

It is therefore an objective of the present invention to provide a self-luminescent display device and display method and portable computer.

The present invention discloses a self-luminescent display device for an electronic device. The self-luminescent display device includes a display screen, for displaying pictures via a plurality of self-luminescent elements. And a display controller receiving an image data corresponding to the image and a control signal corresponding to the status information, to drive the data display area and the status display area to display the image and the status information respectively. The display screen includes a data display area, for displaying an image, and a status display area, for displaying a status information of the electronic device.

The present invention further discloses a display method for a self-luminescent display device. The display method includes dividing a display screen of the self-luminescent display device into a data display area and a status display area, displaying an image via the data display area, and displaying a status information via the status display area.

The present invention further discloses a portable computer. The portable computer includes a operating module for realizing functions of the portable computer, and a self-luminescent display device. The self-luminescent display device includes a display screen for displaying pictures via a plurality of self-luminescent elements, and a display controller for receiving an image data corresponding to the image and a control signal corresponding to the status information. The display controller drive the data display area and the status display area to display the image and the status information, respectively. The display screen includes a data display area for displaying an image, and a status display area for displaying a status information of the portable computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional portable computer.

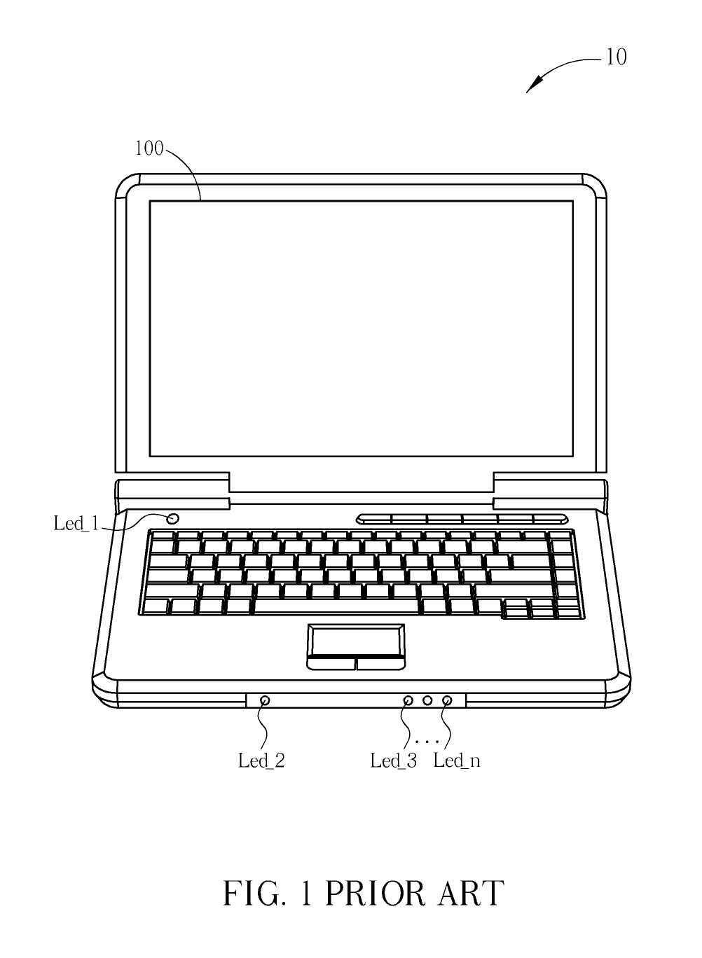

FIG. 2 is a functional block diagram of a portable computer according to an embodiment of the present invention.

FIG. 3 is a schematic diagram of a display process according to an embodiment of the present invention.

### DETAILED DESCRIPTION

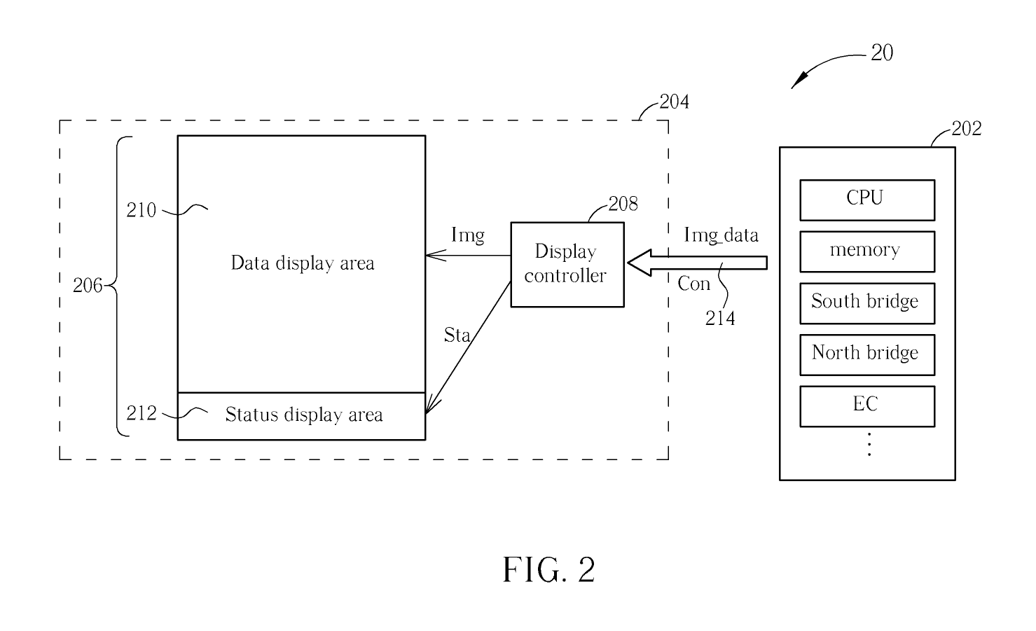

Please refer to FIG. 2, which is a functional block diagram of a portable computer 20 according to an embodiment of the present invention. For simplicity, the portable computer 20 only includes an operating module 202 and a self-luminescent display device 204 in FIG. 2. The operating module 202 can include a central processing unit (CPU), memory, a south bridge, a north bridge, and an embedded controller (EC) for realizing functions of the portable computer 20, which is known by those skilled in the art, and is not narrated hereinafter. The self-luminescent display device 204 is coupled to the operating module 202, and includes a display screen 206 and a display controller 208. The display screen 206 is composed of self-luminescent displaying elements. The display screen 206 includes a data display area 210 and a status display area 212. The self-luminescent displaying elements can be organic light emitting diodes (OLEDs) or plasma molecules, and are not limited to these. The display controller 208 is coupled to the operating module 202 via an interface 214, and receives image data Img_data and a control signal Con, so as to drive the data display area 210 and the status display area 212 to display a corresponding image Img and corresponding status information Sta, respectively. Therefore, the portable computer 20 can display system statuses in colorful and various manners via the status display area 212 without extra light emitting diode (LED) lights and related circuits.

In short, the display controller 208 receives the image data Img data corresponding to the image Img and the control signal Con corresponding to the status information Sta outputted by the operating module 202 via the interface 214, so as to drive the data display area 210 and the status display area 212 to display the image Img and the status information Sta, respectively. Since the display screen 206 displays via OLEDs, the data display area 210 and the status display area 212 can individually light up and display different colors, i.e. the status display area 212 can display the status information Sta when the data display area 210 does not display the image Img. In other words, the status display area 212 may represent a subset of the display screen 206 (i.e. in a lower rectangular area or another part of the display screen 206), and can display the status information Sta such as a system status (S0, S3, S4, S5), num lock status, caps lock status, battery status (charge or not), WLAN card status, Bluetooth status, system temperature, CPU temperature, fan speed and time. In colorful and varied manners according to the control signal Con. Under such a condition, the portable computer 20 can display the system status in colorful and varied manners via the status display area 212 without extra LED lights and related circuits.

Noticeably, FIG. 2 only shows an embodiment of the present invention, and those skilled in the art can make alterations or modifications according to requirements. For example, in FIG. 2, the interface 214 denotes a signal connection between the operating module 202 and the display controller 208. In practice, the signal connection is not limited to a single signal interface, and can include multiple signal lines or signal interfaces, and those skilled in the art can properly adjust related operations according to different realizations, such that the display controller 208 can correctly receive the image data Img_data and the control signal Con. For example, if the interface 214 is realized by a single display interface, such as a low voltage differential signal (LVDS), the display controller 208 can receive the control signal Con via reserved pins while receiving the image data Img_data, or receive the image data Img_data and the control signal Con by time division, respectively. On the other hand, if the interface 214 is realized by multiple interfaces, the display controller 208 can receive the image data Img_data and the control signal Con at the same time.

In the portable computer 20, since the data display area 210 and the status display area 212 can individually light up, even if the system operates in a low power consumption mode (such as sleep states S1-S5) or even in a power-off mode, the status display area 212 can still light up, so as to display the system status in colorful and varied ways. Under such a condition, when the portable computer 20 performs a debug command, a program of the debug command can be directly transferred to the display screen 206 via the EC of the operating module 202 for debugging, and the status display area 212 may display the status information Sta (such as a debug result). Therefore, the portable computer 20 only needs to operate in the low power consumption mode, and does not need to light up all the self-luminescent elements of the display screen 206, in order to reduce power consumption. As a result, the present invention does not need a debug card to debug, and can omit circuits of peripheral component interconnect express (PCI Express) slots for debugging. Furthermore, the EC can be displayed in the status display area 212, and can control a keyboard. Thus, the portable computer 20 can be seen as two computers, one for enhancing convenience of operations of the EC, and another for ordering the EC to perform intended instructions and commands. Therefore, compared with the prior art, the present invention does not need extra LED lights and related circuits to display the system status in colorful and varied ways, and does not need a debug card and debug circuits to perform debugging, so as to further increase application scope and reduce power consumption.

Noticeably, the spirit of the present invention is to assign a data display area and a status display area in a display screen of the self-luminescent display device, in order to independently display the status information in colorful and varied ways according to the control signal. Those skilled in the art can make alterations or modifications according to the spirit of the present invention. For example, other than a portable computer, electronic devices capable of using self-luminescent display devices, such as handheld apparatuses, communication terminals, instruments, and meters, all belong to the scope of the present invention. Moreover, the data display area 210 and the status display area 212 can overlap, i.e. content displayed in the status display area 212 may be overlapped with the image Img and the status information Sta. Certainly, the data display area 210 and the status display area 212 can be separated as well, i.e. the data display area 210 and the status display area 212 exclusively display the image Img and the status information Sta, respectively. In addition, the interface 214 can be a single signal interface, and can include multiple signal interfaces, as long as the display controller 208 can correctly receive the image data Img data corresponding to the image Img and the control signal Con corresponding to the status information Sta.

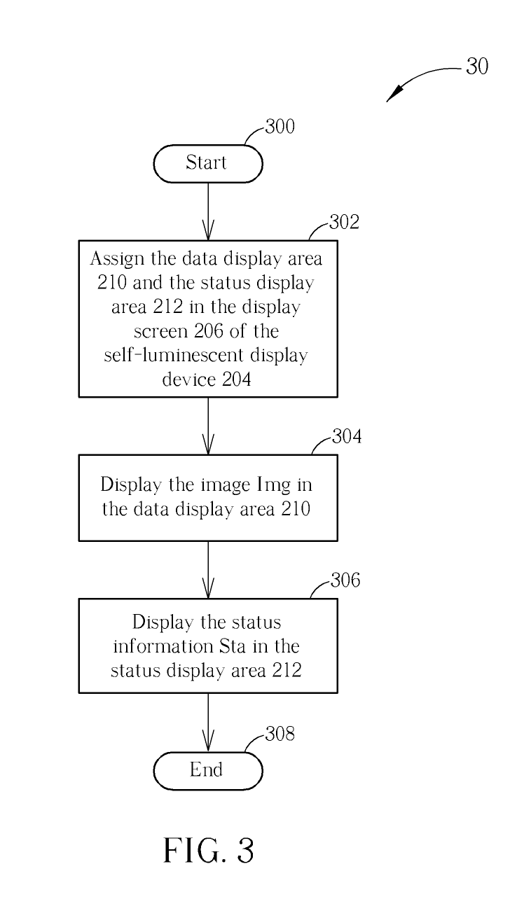

Therefore, display operations of the self-luminescent display device 204 can be summarized into a display process 30, as shown in FIG. 3. The display process 30 includes the following steps:

Step 300: Start.

Step 302: Assign the data display area 210 and the status display area 212 in the display screen 206 of the self-luminescent display device 204.

Step 304: Display the image Img in the data display area 210.

Step 306: Display the status information Sta in the status display area 212.

Step 308: End.

Descriptions of the display process 30 can be referred from the above descriptions and are not narrated hereinafter.

In the prior art, a liquid crystal display device needs extra LED lights and related circuits to indicate system status, which requires extra LED lights and related circuits, and only provides simple on/off switch or blinking to indicate system status. In comparison, the present invention assigns a status display area in a display screen for emitting light via self-luminescent elements to display the status information independently. As a result, the present invention does not need extra LED lights and related circuits to display the system status via the status display area in colorful and varied manners, and does not need a debug card and debug circuits to perform debugging, so as to further increase application scope and reduce power consumption.

To sum up, the present invention can display the system status in colorful and varied ways, and further increases application scope and reduces power consumption.

Those skilled in the art will readily observe that numerous modifications and alterations of the device and method may be made while retaining the teachings of the invention.

What is claimed is:

1. A self-luminescent display device for an electronic device, the self-luminescent display device comprising:
a display screen, for displaying pictures via a plurality of self-luminescent elements, the display screen comprising:
a data display area, for displaying an image; and
a status display area, for displaying status information of the electronic device; and
a display controller, for receiving image data corresponding to the image and a control signal corresponding to the status information, to drive the data display area and the status display area to display the image and the status information, respectively.

2. The self-luminescent display device of claim 1, wherein the display controller receives the image data and the control signal via one interface.

3. The self-luminescent display device of claim 1, wherein the display controller receives the image data and the control signal via a first interface and a second interface, respectively.

4. The self-luminescent display device of claim 1, wherein the electronic device is a portable computer.

5. The self-luminescent display device of claim 1, wherein the plurality of self-luminescent elements are a plurality of organic light emitting diodes (OLEDs).

6. The self-luminescent display device of claim 1, wherein the data display area and the status display area overlap.

7. The self-luminescent display device of claim 1, wherein the data display area and the status display area are separate.

8. A display method for a self-luminescent display device, comprising:
assigning a data display area and a status display area in a display screen of the self-luminescent display device;
displaying an image in the data display area; and
displaying status information in the status display area.

9. The displaying method of claim 8, wherein the self-luminescent display device is utilized in a portable computer.

10. The displaying method of claim 8, wherein the plurality of self-luminescent elements are a plurality of organic light emitting diodes (OLEDs).

11. The displaying method of claim 8, wherein the data display area and the status display area overlap.

12. The displaying method of claim 8, wherein the data display area and the status display area are separate.

13. A portable computer comprising:
an operating module, for realizing functions of the portable computer; and
a self-luminescent display device, coupled to the operating module, comprising:
a display screen, for displaying pictures via a plurality of self-luminescent elements, the display screen comprising:
a data display area, for displaying an image; and
a status display area, for displaying status information of the portable computer; and
a display controller, for receiving image data corresponding to the image and a control signal corresponding to the status information, to drive the data display area and the status display area to display the image and the status information, respectively.

14. The portable computer of claim 13, wherein the display controller receives the image data and the control signal via one interface.

15. The portable computer of claim 13, wherein the display controller receives the image data and the control signal via a first interface and a second interface, respectively.

16. The portable computer of claim 13, wherein the plurality of self-luminescent elements are a plurality of organic light emitting diodes (OLEDs).

17. The portable computer of claim 13, wherein the data display area and the status display area overlap.

18. The portable computer of claim 13, wherein the data display area and the status display area are separate.
